(19) United States
(12) Patent Application Publication
(10) Pub. No.: US 2006/0228143 A1
(43) Pub. Date: Oct. 12, 2006

(54) Portable printer enabling to directly print on an object surface

(76) Inventor: Hsiu Chi Kuo, Tainan (TW)

Correspondence Address: LIN & ASSOCIATES INTELLECTUAL PROPERTY, P.O. BOX 2339, SARATOGA, CA, 95070-0339, US

(21) Appl. No.: 11/101,022

(22) Filed: Apr. 6, 2005

(51) Int. Cl. B41J 3/36

(52) U.S. Cl. 400/88

(57) ABSTRACT

A portable printer includes a printing assembly having a ink cartridge mounted on a moving device which is mounted on a fixed bracket and a frame, which has the printing assembly mounted thereunder, having a data transmission interface and a control unit for processing to-be-printed information and to control the printing assembly. The printing assembly is able to directly print on an object surface.

### BACKGROUND OF THE INVENTION

1. Field of the Invention

The present invention relates to a portable printer, and more particularly to a portable printer to directly print on an object surface.

2. Description of Related Art

Due to the advanced modem technology, personal handwriting, engineering drawings or the like is able to be printed out directly via a printer. From the output color change and the resolution advanced, the modem printer is gradually replacing handwriting.

However, the printer requires the printable media such as a sheet of paper be fed into the feeder before the printing process starts. Then via the reciprocal movement of the ink cartridge and the gradual advancement of the printable media into the printer, a pattern is printed onto the printable media. That is, all the existed printer passively receives the printable media via the paper feeder and is not able to print the desired pattern onto any printable surface. Cut-and-paste process is involved if the printable media is a wall or a closet surface. The user will have to first print the desired pattern onto a sheet of paper and then the desired pattern is cut for paste onto the wall or the closet surface, which is not able to present a vivid effect. Furthermore, the existed printers are connected to personal computers (PC) for printout, which makes it difficult to move the printer to wherever necessary.

### SUMMARY OF THE INVENTION

The primary objective of the present invention is to provide an improved portable printer to printout directly onto a printable media.

Other objects, advantages, and novel features of the invention will become more apparent from the following detailed description when taken in conjunction with the accompanying drawings, in which:

### BRIEF DESCRIPTION OF THE DRAWINGS

FIG. 1 is an exploded view of a portable printer of the present invention, wherein the frame and the printing assembly are reversed for easy understanding;

FIG. 2 is a schematic side plan view showing the frame;

FIG. 3 is a schematic top plan view showing the arrangement of the printing assembly relative to the frame;

FIG. 4 is an enlarged perspective view of the lateral sliding block of the present invention;

FIG. 5 is a schematic cross-sectional view showing the interior of the vertical sliding block;

FIGS. 6 and 7 are schematic views showing application of the portable printer of the present invention on a vertical surface and a horizontal surface.

### DETAILED DESCRIPTION OF PREFERRED EMBODIMENT

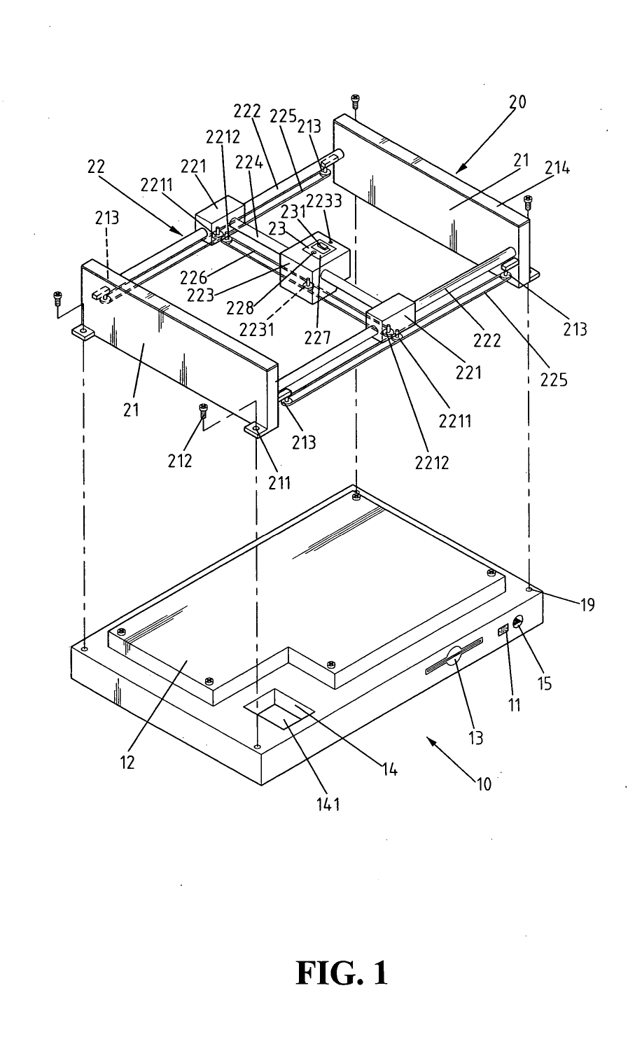

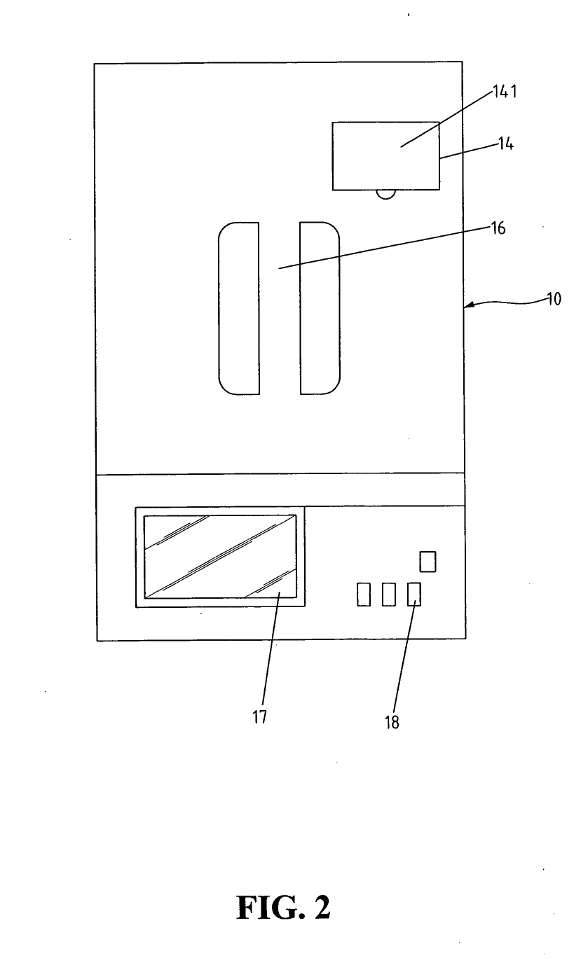

With reference to FIGS. 1 and 2, it is noted that the portable printer in accordance with the present invention includes a frame 10 and a printing assembly 20. The frame 10 has a data transmission interface 11 and a control unit 12. The data transmission interface 11 is able to connect to a PC so that a desired pattern can be transmitted to the portable printer of the present invention. The data transmission interface 11 may be a USB (universal serial bus) interface, an IEEE1394 (institute of electrical and electronic engineers 1394) interface or the like. The control unit 12 is mounted on the bottom of the frame 10 to process the data transmitted into the portable printer and to control the printing assembly 20, which may include for example a circuit board, a microprocessor, or a battery set.

In addition, the frame 10 has a data card slot 13 and a display 17 so that even when the PC is off, the information stored in a storage media such as a CF (compact flash) card, SM (secure digital) card, MMC (multimedia card) or an XD (extreme digital) card can still be displayed on the display 17 directly. The display 17 may be a liquid crystal display (LCD) or any interface that is able to present a data image. The frame 10 may also provide with a handle 16 for easy carry. The handle 16 preferably is composed of a recessed area defined in a top face of the frame 10 and a bar interconnecting two opposed side face defining the recessed area so that the user is able to hold the bar and carry the printer. In addition, the frame 10 has a plug 15 and a switch 18 to respectively supply power to the printer and activate the printing process of the printer.

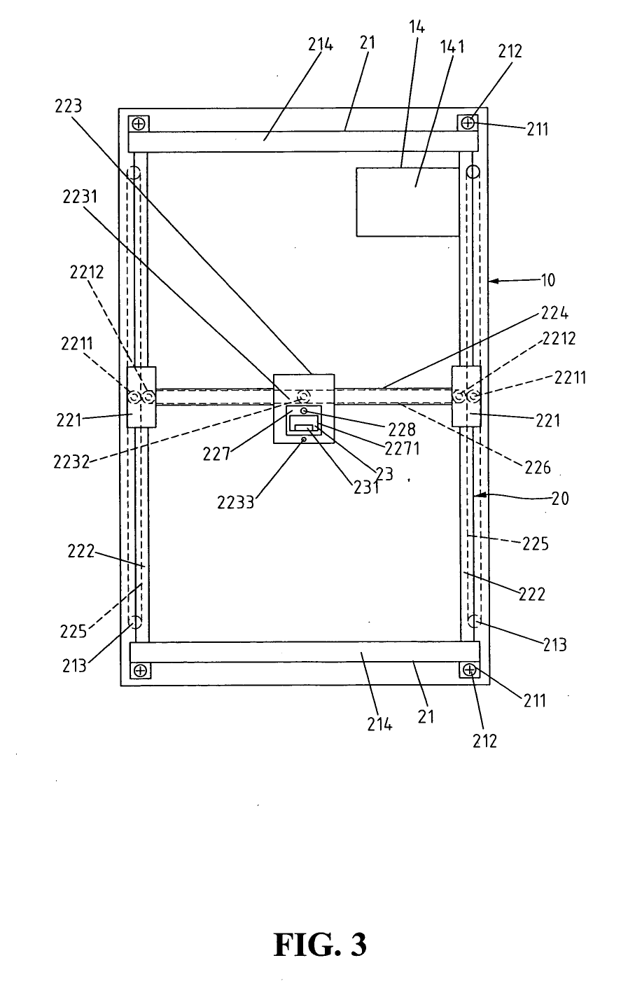

The printing assembly 20, as shown in FIGS. 2 and 3, is mounted under the frame 10 and has a fixed bracket 21, a moving device 22, and a ink cartridge 23. The fixed bracket 21 is securely connected to the frame 10 and the moving device 22 includes two longitudinal sliding blocks 221, two longitudinal sliding rods 222, a lateral sliding block 223, a lateral sliding rod 224, a vertical sliding block 227 and a vertical sliding rod 228. Each of the two longitudinal sliding blocks 221 is connected to a corresponding one of the two longitudinal sliding rods 222 which in turn are provided between two opposite side walls of the fixed bracket 21. The lateral sliding block 223 is connected to the lateral sliding rod 224, which is mounted, between the two longitudinal sliding blocks 221. The lateral sliding block 223 has therein the vertical sliding rod 228 and the vertical sliding block 227 is connected to the vertical sliding rod 228.

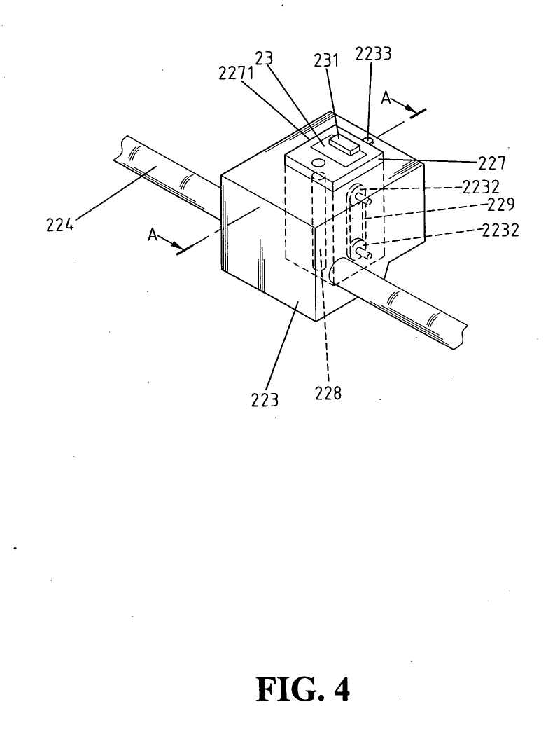

Adjacent to each of the two opposite ends of the longitudinal sliding rods 222, a first longitudinal pulley 213 is mounted. Inside the fixed bracket 21, a first motor (not shown) is provided. A second longitudinal pulley 2211 and a first lateral pulley 2212 are provided on each of the two longitudinal sliding blocks 221. Inside one of the two longitudinal sliding blocks, a second motor (not shown) is provided. A second lateral pulley 2231 is mounted on the lateral sliding block 223. The first motor is provided to drive the longitudinal pulleys 213, 2211 via a longitudinal belt 225 and the second motor is provided to drive the lateral pulleys 2212, 2232 via a lateral belt 226. The lateral sliding block 223 is further provided with two vertical pulleys 2232. A vertical belt 229, as shown in FIG. 4, is mounted around the two vertical pulleys 2232 and connected to a third motor (not shown) inside the lateral sliding block 223.

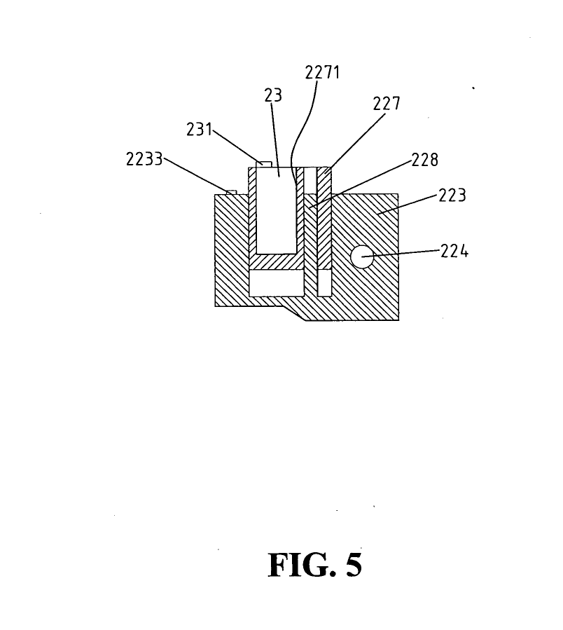

With reference to FIGS. 4 and 5, the ink cartridge 23 is mounted in a slot 2271 inside the vertical sliding block 227. The cartridge 23 has a nozzle 231. At a front side of the vertical sliding block 227, a distance measuring element 2233 is mounted for measuring distance between the nozzle 231 and a surface of the to-be printed object. The distance measuring element 2233 is operably connected to a control unit 12 on top of the frame 10 so that after a precise distance between the nozzle 231 and a surface of the to-be printed object is detected, the distance is sent to the control unit 12 to control movement of the nozzle 231 so as to eject proper amount of ink to the surface of the to-be printed object. Furthermore, to facilitate access to the ink cartridge 23 for replacement of the ink cartridge 23, an opening 14 is defined in the frame 10 and a cover 141 is provided to close the opening 14 such that opening the cover 141, the user is able to have the access to the ink cartridge 23.

The fixed bracket 21 has multiple threaded holes 211 defined in an outer periphery of the fixed bracket 21 to align with threaded holes 19 of the frame 10 such that threaded bolts 212 are employed to extended into the aligned threaded holes 19, 211 to combine the frame 10 and the fixed bracket 21. A layer of padding 214 is mounted on a bottom face of the fixed bracket 21 so that when the fixed bracket 21 is engaging with the to-be-printed object surface, the engagement therebetween is secured. Preferably, the padding is made of rubber or any material that is slit-proof.

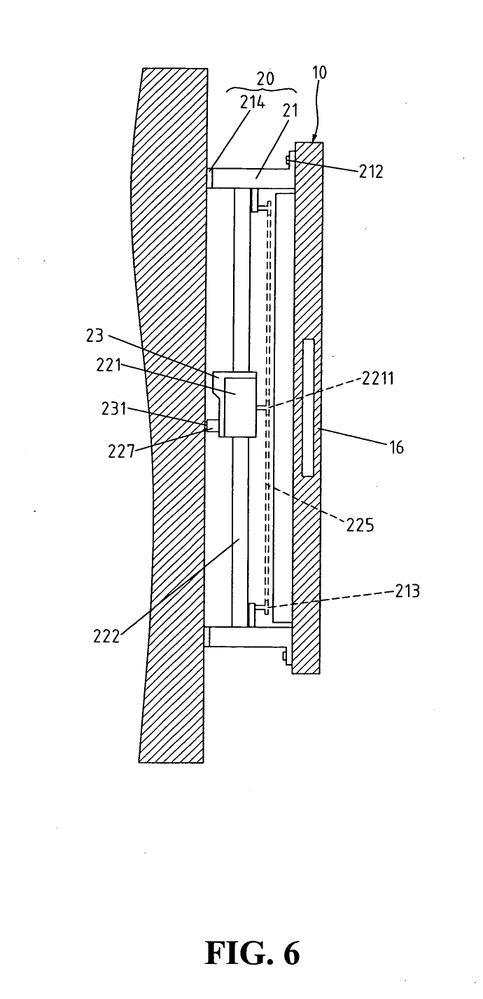

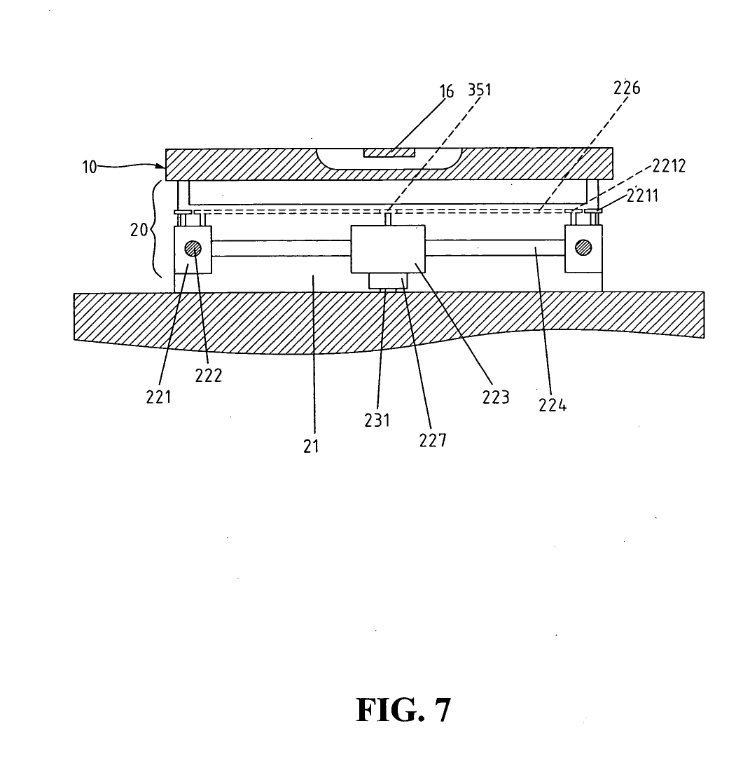

When the printing assembly 20 of the present invention is in application, the information to be printed onto the object and stored in the computer is sent to the control unit 12 via the data transmission interface 11 or a memory card having stored therein the to-be-printed information is inserted into the data card slot 13 and presented by the display 17. After the information is confirmed by the user, the printer of the present invention is moved to the object (referring to FIGS. 6 and 7) and the padding 214 helps ensure that the engagement between the printer and the object is secured.

When the computer sends out a printing command or the switch 18 is activated, the control unit 21 starts to control the motors inside the fixed bracket 21 and the longitudinal sliding block 221 as well as the first longitudinal pulley 213 and the first lateral pulley 2212. Thus when lateral printing is required, the second motor inside the longitudinal sliding block 221 starts rotation and the first lateral pulley 2212 is driven to drive the vertical pulley 2232 on the lateral sliding block 223 via the longitudinal belt 225 so that the lateral sliding block 223 is able to move on the lateral rod 222. While the lateral sliding block 223 is moving on the lateral rod 222, the ink cartridge 23 is moved accordingly. As a consequence of the movement of the ink cartridge 23, the nozzle 231 is able to inject ink onto the object surface. After the lateral printing on a particular row is finished, the motor inside the longitudinal sliding block 221 starts to reverse rotation, which drives the lateral pulley 2212 to reverse rotation. The lateral sliding block 223 is driven back to its original position via the lateral belt 226. Thereafter, the first motor inside the fixed bracket 21 starts rotation to drive the first longitudinal pulley 213, which drives the second longitudinal pulley 2211 on the longitudinal sliding block 221. Thus the two longitudinal sliding blocks 221 are moved on the lateral rod 222. When the two longitudinal sliding blocks 221 reach a predetermined position, the motor inside the longitudinal sliding block 221 starts rotation to drive the second lateral pulley 2212. Therefore, the cross work of the longitudinal and lateral movement of the printing assembly 20 enables entire to-be printed information to print onto the object surface.

The vertical sliding block 227 is able to extend out of or retract into the lateral sliding block 223 when the distance measuring element 2233 detects bumps or recesses on the object surface. The movement of the vertical sliding block 227 is controlled by the control unit 12. Therefore, the portable printer of the present invention is able to overcome two dimensional printing limitation and to proceed three dimensional printing process. Preferably, the distance measuring element 2233 is a infrared or ultrasonic distance detection device or any suitable device having the same feature.

If the object surface is larger than that of the frame 10, the control unit 12 is able to firs divide the object surface into sections and respectively show on the display 17 so that the printing assembly 20 can still print out the entire information onto a large area.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable printer comprising:
a printing assembly having a ink cartridge mounted on a moving device which is mounted on a fixed bracket; and
a frame, which has the printing assembly mounted thereunder, having a data transmission interface and a control unit for processing to-be-printed information and to control the printing assembly,
whereby the printing assembly is able to directly print on an object surface.

2. The portable printer as claimed in claim 1, wherein the moving device is mounted on a fixed bracket.

3. The portable printer as claimed in claim 2, wherein the moving device includes two longitudinal sliding blocks, two longitudinal sliding rods, a lateral sliding block, a lateral sliding rod, a vertical sliding block and a vertical sliding rod, wherein each of the two longitudinal sliding blocks is connected to a corresponding one of the two longitudinal sliding rods which in turn are provided between two opposite side walls of the fixed bracket, the lateral sliding block is connected to the lateral sliding rod which is mounted between the two longitudinal sliding blocks, the lateral sliding block has therein the vertical sliding rod and the vertical sliding block is connected to the vertical sliding rod.

4. The portable printer as claimed in claim 3, wherein adjacent to each of the two opposite ends of the longitudinal sliding rods, a first longitudinal pulley is mounted, inside the fixed bracket, a first motor is provided, a second longitudinal pulley and a first lateral pulley are provided on each of the two longitudinal sliding blocks, inside one of the two longitudinal sliding blocks, a second motor is provided, a second lateral pulley is mounted on the lateral sliding block, the first motor is provided to drive the longitudinal pulleys via a longitudinal belt and the second motor is provided to drive the lateral pulleys via a lateral belt, the lateral sliding block is further provided with two vertical pulleys, a vertical belt is mounted around the two vertical pulleys and connected to a third motor inside the lateral sliding block.

5. The portable printer as claimed in claim 1, the data transmission interface is a USB.

6. The portable printer as claimed in claim 1, the data transmission interface is an IEEE1394 interface.

7. The portable printer as claimed in claim 1, wherein the frame further has a data card slot.

8. The portable printer as claimed in claim 7, wherein the data card slot is a memory card slot.

9. The portable printer as claimed in claim 8, wherein the frame further has a display.

10. The portable printer as claimed in claim 9, wherein the display is a liquid crystal display.

11. The portable printer as claimed in claim 1, wherein the frame has a handle, a switch, and a plug.

12. The portable printer as claimed in claim 1, wherein the frame has an opening corresponding to the ink cartridge and a cover to selectively cover the opening.

13. The portable printer as claimed in claim 1, wherein the vertical sliding block has a slot to securely receive therein the ink cartridge.
